(19) United States
(12) Patent Application Publication
(10) Pub. No.: US 2019/0079034 A1
(43) Pub. Date: Mar. 14, 2019

(54) METHOD AND DEVICE FOR DETERMINING CONCENTRATION OF GAS COMPONENTS IN A GAS MIXTURE

(71) Applicant: Process-Electronic GmbH, Heiningen (DE)

(72) Inventor: Edgar Falkowski, Geislingen an der Steige (DE)

(73) Assignee: Process-Electronic GmbH, Heiningen (DE)

(21) Appl. No.: 15/999,353

(22) PCT Filed: Jan. 18, 2017
(86) PCT No.: PCT/EP2017/050934

§ 371 Date: Aug. 17, 2018

(30) Foreign Application Priority Data
Feb. 18, 2016 (DE) 10 2016 202 537.6

(51) Int. Cl. G01N 25/20; C23C 8/24; C21D 11/00

(52) U.S. Cl. CPC G01N 25/20; C21D 11/00; C23C 8/24

(57) ABSTRACT

The invention relates to a method and to a device for determining the concentration of N gas components in a gas mixture which has at least N gas components, where N is greater than 2, wherein a sensor element (1) or multiple sensor elements (1) is/are brought to N−1 predefined temperature values for the purpose of determining temperature-dependent heat conductivities, and wherein the at least one sensor element (1) is brought at least to a minimum temperature value (Tₘᵢₙ) in a range from approximately 60° to approximately 350°, and to a maximum temperature value (Tₘₐₓ) in a range of greater than approximately 350°.

### FIELD OF APPLICATION AND PRIOR ART

The invention relates to a method and to a device for determining the concentration of gas components in a gas mixture. The invention relates in particular to a method and to a device for determining the concentrations of process-relevant gas components in nitriding or nitrocarburizing atmospheres. The invention also relates to a heat-treatment furnace.

Various methods and devices for determining the gas concentrations are known from the prior art.

For example, DE 37 11 511 C1 describes a method for determining the gas concentrations in a gas mixture through the use of the different heat conductivity of different gases, wherein, in order to determine the concentration of N gas components, measurements are performed at N−1 gas temperatures. The analyzers used here comprise a heat source, through which the gas mixture to be analyzed is able to flow, and a heat sink. A resistance heating element serving as a heat source is, by means of current passage, brought to a temperature which is elevated in relation to its surroundings. Heat is conducted by the gas mixture from the heat source to the heat sink, which heat sink is kept at constant temperature, via a heat conducting section which is defined by the geometry. Owing to the heat transport from the heat source to the heat sink, energy is extracted from the heat source, which energy is a measure for the heat conductivity of the gas mixture and can be measured using methods which have been set up and/or designed. In order to eliminate influences of the temperature coefficient of the heat conduction, the measurement cell is thermostated, that is to say is kept at constant temperature by electronic regulation. Apart from the temperature of the measurement cell, the average gas temperature in the heat conducting section is determined by the temperature of the heat source. Consequently, this too is kept constant or set to be reproducible.

EP 1 222 454 B1 discloses a method in which the heat conductivities are determined for a temperature time function which varies between a minimum and a maximum temperature value in a periodic manner, and the heat conductivities which are obtained for the temperature time profile are determined continuously as a function of time, and wherein the time function of the heat conductivity is subjected to a Fourier analysis and the concentrations of the gas components are determined from the coefficients of this Fourier analysis.

### Problem and Solution

The object of the invention is to provide a method and a device for determining with high accuracy the concentration of at least one gas component in a gas mixture.

Provided according to a first aspect is a method for determining the concentration of N gas components in a gas mixture which has at least N gas components, where N is greater than 2, wherein a sensor element or multiple sensor elements is/are brought to at least N−1 predefined temperature values for the purpose of determining temperature-dependent heat conductivities, and wherein the at least one sensor element is brought at least to a minimum temperature value in a range from approximately 60° to approximately 350°, in particular to approximately 120°, and to a maximum temperature value in a range of greater than approximately 350°, in particular in a range from approximately 350° to approximately 550°.

Provided according to a second aspect is a device for determining the concentration of N gas components in a gas mixture which has at least N gas components, where N is greater than 2, comprising a sensor element or multiple sensor elements which is/are set up and/or designed to be brought to at least N−1 predefined temperature values for the purpose of determining temperature-dependent heat conductivities, wherein the at least one sensor element is set up and/or designed to be brought at least to a minimum temperature value in a range from approximately 60° to approximately 350°, in particular to approximately 120°, and to a maximum temperature value in a range of greater than approximately 350°, in particular from approximately 350° to approximately 550°.

The heat conductivity of gas mixtures with N components and with the substance amounts X is, in a first approximation, obtained from the mixing rule λ_{M}=X₁λ₁+X₂λ₂+ . . . +X_{N}·λ_{N}. The heat conductivity of the N-fold gas mixture is detected by way of at least N different temperature values. Preferably, as a result of a normalized calibration of the individual gas components at the corresponding temperatures, the temperature-dependent heat conductivities are eliminated, with the result that the sensor signal for each gas is determined as a function of the gas fraction. For the normalization, use is made in particular of the heat conductivities at 0% and 100% of the individual gas components.

With calibration and measurement under atmospheric pressure of an N-fold gas mixture by way of at least N−1 measurements, the system of equations describing the gas composition is consequently fully determined and thus uniquely solvable for the respective volume fractions using known methods.

This is the case inter alia with the constraints that the temperature-dependent heat conductivities are independent of one another and the substance-specific transfer functions for the measurement signal are strictly monotonic. Said constraints are satisfied in the case of the selected gases.

Conventional methods and devices work in a range of approximately 60 to approximately 115° for the detection of different heat conductivities. The range, which is significantly larger in comparison with conventional methods and devices, allows a more accurate measurement of the individual gas components.

The minimum and the maximum temperature may be suitably selected according to a gas mixture. In this case, it should be taken into consideration that it is possible to carry out measurements of combustible gas components in the presence of oxygen up to the lower ignition limit of the gases. In protective gas atmospheres without the presence of oxygen, the measurement is possible without said restrictions and independent of the actual composition.

Preferably, the at least one sensor element is brought to a maximum temperature value which is above the splitting temperature of at least one gas component of the gas mixture. By contrast, the minimum temperature value is selected such that it is below the splitting temperature of this gas component. Here, use is made of the effect that, with the splitting, molecules of this gas component require a measurable additional energy contribution. This therefore leads to an increase in accuracy, with the breakdown of the molecules having no influence or only a very small influence on the concentration.

This is in particular advantageous for determining the concentrations of process-relevant gas components in nitriding and/or nitrocarburizing atmospheres, wherein ammonia (NH3) which is present in the gas mixture is split into nitrogen and hydrogen and the more accurate measurement of the constituents ammonia and hydrogen thereby becomes possible. Thus, for example, the heat conductivity of ammonia is tabulated only up to approximately 400° C. because, above this temperature, the gas is unstable owing to the splitting which starts. For other gases, such as for example CH4, other temperature limits apply accordingly.

In advantageous configurations, the at least one sensor element comprises a nickel wire or a platinum wire, wherein, in one configuration, the wire is embedded in a ceramic material. These materials allow operation in the temperature range of the invention.

The heat conductivity is normally both temperature-dependent and pressure-dependent. Therefore, in one advantageous configuration, by means of a pressure sensor, a pressure is detected, in particular a pressure prevailing in a measurement chamber, in order to compensate for a pressure dependency of the heat conductivities of the gas components.

The sensor element or the sensor elements is/are able to be designed in a suitable manner by a person skilled in the art and is/are able to be installed in a suitable circuit with other components. In advantageous configurations, the at least one sensor element is exposed to the gas mixture, and a reference element which is assigned to the sensor element is exposed to a reference gas, for example air. If multiple sensor elements are used, these are preferably each assigned one reference element exposed to the reference gas.

In one configuration, N sensor elements are provided, each of which is operated at a defined constant temperature. It is consequently also possible to determine the gas concentrations in a low vacuum (1-1013 mbar), wherein impermissible heating of the sensor element owing to a heat conductivity which is highly reduced in the low vacuum is prevented.

In one configuration, the at least one sensor element and, if present, the reference element are arranged in a measurement chamber, wherein the temperature of the measurement chamber is controlled to a constant temperature. The temperature in the measurement chamber is preferably below the minimum temperature value to which the at least one sensor element is brought. Thus, in one configuration, it is provided to heat the measurement chamber to temperatures in the range from approximately 40° to approximately 50°.

Provided according to a third aspect is a heat-treatment furnace having means for carrying out the method described and/or having a device as described for determining the concentration of process-relevant gas components in a nitriding or nitrocarburizing atmosphere. The heat-treatment furnace serves, for example, for heat treatments, such as gas nitriding, gas nitrocarburizing or gas carbonitriding, of steel components.

### BRIEF DESCRIPTION OF THE DRAWINGS

Further advantages and aspects of the invention will emerge from the claims and from the following description of preferred exemplary embodiments of the invention, which are explained below on the basis of the figures.

In the figures:

FIG. 1 schematically shows a sensor element for determining a heat conductivity for a device for determining the concentration of N gas components in a gas mixture,

FIG. 2 schematically shows a profile of a temperature of the sensor element 1, and

FIG. 3 schematically shows a device for determining the concentration of N gas components in a gas mixture at a heat-treatment furnace.

### DETAILED DESCRIPTION OF THE EXEMPLARY EMBODIMENTS

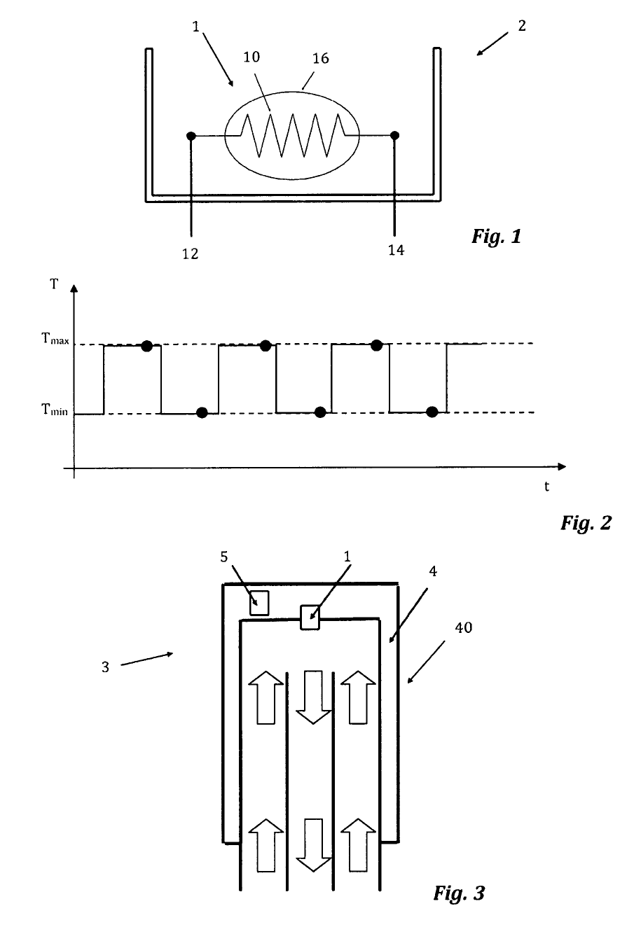

FIG. 1 schematically shows a sensor element 1 for determining a heat conductivity for a device for determining the concentration of N gas components in a gas mixture surrounding the sensor element 1.

The illustrated sensor element 1 comprises a nickel wire or a platinum wire 10 with connections 12, 14, which is surrounded by a ceramic embedding feature 16. A sensor element 1 of said type permits an operation in which the sensor element 1 is brought to a maximum temperature value in a range of greater than 350°. For safe operation at these temperature values, a flame arrester 2, for example composed of stainless steel sintered material, is provided.

By means of the connections 10, 12, the sensor element 1 is brought to at least a minimum temperature value in a range from approximately 60° to approximately 350°, or to a maximum temperature value in a range of greater than 350°. The minimum and the maximum temperature values are in this case selected such that the minimum temperature value is below, and the maximum temperature value is above, the splitting temperature of a gas component.

In one configuration, the sensor element 1 is alternately brought to the minimum temperature value and the maximum temperature value, wherein the temperature profile is preferably a rectangular signal.

FIG. 2 schematically shows a profile of the target temperature T of the sensor element 1, wherein the sensor element 1 is alternately brought to the minimum temperature value Tₘᵢₙ and the maximum temperature value Tₘₐₓ. Detection of the heat conductivity is realized for example at measurement times, or measurement points, represented by points.

In another configuration, two sensor elements 1 are provided, with one sensor element 1 being permanently operated for setting the minimum temperature value Tₘᵢₙ and one sensor element 1 being permanently operated for setting the maximum temperature value Tₘₐₓ. The constant temperature profiles of said sensor elements 1 are illustrated by dashed lines in FIG. 2.

In yet further configurations, the sensor element 1 is repeatedly brought to the minimum temperature value, at least one intermediate value and the maximum temperature value in a stepwise manner.

In one configuration, the sensor element 1 is operated under atmospheric pressure in a Wheatstone bridge. Other circuits are also conceivable, however.

The concentrations of N gas components in a gas mixture surrounding the sensor element 1 are detected in an evaluation unit (not illustrated), on the basis of the detected N−1 measurement values.

FIG. 3 schematically shows a device 3 for determining the concentration of N gas components in a gas mixture at a heat-treatment furnace (not illustrated). The device 3 comprises a measurement chamber 3 having a housing 30. The temperature of the measurement chamber 3 is controlled to a constant temperature. In order to prevent condensation of water, the temperature is preferably 100° C. Depending on the gas mixture, it is possible for example for the temperature also to be fixed at approximately 70-80° C. utilizing the influence of NH3 at 100° C. Heating of the measurement chamber 3 is preferably realized by means of a heated housing 30.

In the illustrated exemplary embodiment, the sensor element 1 and a reference element 5 are arranged in the measurement chamber 4, wherein the sensor element is exposed to the gas mixture to be analyzed and the reference element is exposed to a reference gas, for example air.

A flow of the gas mixture to be analyzed is schematically illustrated by arrows.

The measurement chamber 4 is flange-mounted for example on a housing of the heat-treatment furnace (not illustrated), wherein a throughflow of the measurement chamber with the sensor element 1 by a gas flow generated by physical causes is realized such that the measurement chamber 40 is flowed against without active elements at a temperature which is relatively low in comparison with the heat-treatment furnace, and the gas passes back to the heat-treatment furnace via a gas return line which is advantageously arranged centrally.

1. A method for determining the concentration of N gas components in a gas mixture which has at least N gas components, where N is greater than 2, wherein a sensor element or multiple sensor elements is/are brought to at least N−1 predefined temperature values for the purpose of determining temperature-dependent heat conductivities, wherein the at least one sensor element is brought at least to a minimum temperature value in a range from approximately 60° to approximately 350°, and to a maximum temperature value in a range of greater than approximately 350°.

2. The method as claimed in claim 1, wherein the maximum temperature value is above the splitting temperature of at least one gas component of the gas mixture, and the minimum temperature value is below the splitting temperature of this gas component of the gas mixture.

3. The method as claimed in claim 1, wherein, by means of a pressure sensor, a pressure is detected in order to compensate for a pressure dependency of the heat conductivities of the gas components.

4. The method as claimed in claim 1, wherein the at least one sensor element is exposed to the gas mixture, and a reference element which is assigned to the sensor element is exposed to a reference gas, in particular air.

5. The method as claimed in one of claim 1, wherein N−1 sensor elements are provided, each of which is operated at a defined constant temperature.

6. A device for determining the concentration of N gas components in a gas mixture which has at least N gas components, where N is greater than 2, comprising a sensor element or multiple sensor elements which is/are set up and/or designed to be brought to at least N−1 predefined temperature values for the purpose of determining temperature-dependent heat conductivities, wherein the at least one sensor element is set up and/or designed to be brought at least to a minimum temperature value in a range from approximately 60° to approximately 350°, and to a maximum temperature value in a range of greater than approximately 350°.

7. The device as claimed in claim 6, wherein the at least one sensor element is set up and/or designed to be brought to a maximum temperature value which is above the splitting temperature of the gas mixture.

8. The device as claimed in claim 6, wherein the at least one sensor element comprises a nickel wire and/or a platinum wire, wherein the nickel wire and/or the platinum wire are/is embedded in particular in a ceramic material.

9. The device as claimed in claim 6, wherein a pressure sensor is provided for detecting a pressure.

10. The device as claimed in claim 6, wherein at least one sensor element, which is exposed to the gas mixture, and a reference element are provided, wherein the reference element is exposed to a reference gas, in particular air.

11. The device as claimed in claim 6, wherein N−1 sensor elements are provided, each of which is set up and/or designed to be operated at a defined constant temperature.

12. The device as claimed in claim 6, wherein the at least one sensor element is arranged in a measurement chamber, wherein the temperature of the measurement chamber is controlled to a constant temperature.

13. A heat-treatment furnace having a device as claimed in claim 6 for determining the concentration of process-relevant gas components in a nitriding or nitrocarburizing atmosphere.
